(19) United States
(12) Patent Application Publication
(10) Pub. No.: US 2020/0294101 A1
(43) Pub. Date: Sep. 17, 2020

(54) SYSTEM AND METHOD FOR PREDICTIVE ROUTING TO PERSONALIZED BOTS

(71) Applicant: Genesys Telecommunications Laboratories, Inc., Dale City, CA (US)

(72) Inventors: Cliff W. Bell, Kalispell, MT (US); Daniel Stewart Stoops, Powell, OH (US)

(21) Appl. No.: 16/814,314

(22) Filed: Mar. 10, 2020

Related U.S. Application Data
(60) Provisional application No. 62/817,129, filed on Mar. 12, 2019.

(51) Int. Cl. G06Q 30/02; G06N 20/00; H04L 12/58

(52) U.S. Cl. CPC G06Q 30/0281; G06F 40/40; H04L 51/02; G06N 20/00

(57) ABSTRACT

A collection of bots is provided that can support predictive routing through mapping customers to the bots. The variety of bot personalities may be provided in a plurality of dimensions such as: utterances used for recognition training, intents supported, and the responses the bot provides. A bot can be trained on collected utterances that are segmented by predictive routing. Human agents who have been classified can be used to segment utterance training so that a specific bot instantiation is trained on utterances typical of a customer who prefers that agent classification. Supported intents can be reflective of the utterance training for the specific classification of an agent. The responses of the bot can also be tailored to the personality typical of the age classification. Each bot response can be syntactically different in a conversation based on the bot segmentation.

### CROSS REFERENCE TO RELATED APPLICATION

This application claims the benefit of U.S. Provisional Patent Application No. 62/817,129, titled “SYSTEM AND METHOD FOR PREDICTIVE ROUTING TO PERSONALIZED BOTS”, filed in the U.S. Patent and Trademark Office on Mar. 12, 2019, the contents of which are incorporated herein.

### BACKGROUND

The present invention generally relates to customer interaction management systems and methods, as well as predictive routing of interactions. More particularly, the present invention pertains to the predictive routing of interactions to chat bots.

### SUMMARY

A system and method are presented for predictive routing to personalized bots. A collection of bots is provided that can support predictive routing through mapping customers to the bots. The variety of bot personalities may be provided in a plurality of dimensions such as: utterances used for recognition training, intents supported, and the responses the bot provides. A bot can be trained on collected utterances that are segmented by predictive routing. Human agents who have been classified can be used to segment utterance training so that a specific bot instantiation is trained on utterances typical of a customer who prefers that agent classification. Supported intents can be reflective of the utterance training for the specific classification of an agent. The responses of the bot can also be tailored to the personality typical of the age classification. Each bot response can be syntactically different in a conversation based on the bot segmentation.

In one embodiment, a system is presented for routing an interaction with a customer to a first chat bot of a plurality of chat bots associated with a contact center environment, based on criteria for automatic handling in the contact center environment, comprising: a processor; and a memory in communication with the processor, the memory storing instructions that, when executed by the processor, causes the processor to route the interaction to the first chat bot by: analyzing a plurality of dimensions of historical interactions associated with a profile of the customer to obtain one or more differentiators for the interaction; comparing the one or more differentiators against the differentiators associated with each chat bot of the plurality of chat bots; selecting the first chat bot that is a best match from the plurality of chat bots; and routing the interaction to the first chat bot for handling.

Each of the plurality of chat bots has a distinct persona constructed from a plurality of dimensions associated with agent personalities in the contact center environment. An agent personality is associated with a cluster of similar agents for the contact center environment. The plurality of dimensions may also comprise one or more of utterances for training a bot's recognition, intents a bot supports, and responses an agent provides.

In another embodiment, a method is provided for routing an interaction to a chat bot from a plurality of chat bots based on criteria for automatic handling in a contact center environment, comprising: analyzing a plurality of dimensions of historical interactions associated with a profile of the customer to obtain one or more differentiators for the interaction; comparing the one or more differentiators against the differentiators associated with each chat bot of the plurality of chat bots; selecting a first chat bot that is a best match from the plurality of chat bots; routing the interaction to the first chat bot for handling; monitoring the interaction for changes, wherein the changes indicate the first chat bot is not a best match; comparing the one or more differentiators against the differentiators associated with each chat bot of the plurality of chat bots; selecting a second chat bot that is a best match from the plurality of chat bots; and routing the interaction to the second chat bot for handling.

In an embodiment, the interaction may be continued to be monitored for changes, wherein the changes indicate the second chat bot is not a best match; comparing the one or more differentiators against the differentiators associated with each chat bot of the plurality of chat bots; selecting an other chat bot that is a best match from the plurality of chat bots; and routing the interaction to the second chat bot for handling.

Each of the plurality of chat bots has a distinct persona constructed from a plurality of dimensions associated with agent personalities in the contact center environment. An agent personality is associated with a cluster of similar agents for the contact center environment. The plurality of dimensions may also comprise one or more of utterances for training a bot's recognition, intents a bot supports, and responses an agent provides.

In another embodiment, a system is presented for routing an interaction with a customer to a first chat bot of a plurality of chat bots associated with a contact center environment, wherein, it is identified that a first chat bot does not meet a threshold for routing and a new chat bot is needed, based on criteria for automatic handling in the contact center environment, comprising: a processor; and a memory in communication with the processor, the memory storing instructions that, when executed by the processor, causes the processor to route the interaction to the first chat bot by: analyzing a plurality of dimensions of historical interactions associated with a profile of the customer to obtain one or more differentiators for the interaction; comparing the one or more differentiators against the differentiators associated with each chat bot of the plurality of chat bots; selecting the first chat bot that is a best match from the plurality of chat bots; determining that the first chat bot does not meet a performance threshold for the differentiators compared to a similar persona of agents in the contact center environment; and creating a notification that a new chat bot is needed.

The notification may comprise data on new differentiators needed for the new chat bot to address the new persona. The plurality of dimensions comprises one or more of: utterances for training a bot's recognition, intents a bot supports, responses an agent provides, and responses a customer provides.

### BRIEF DESCRIPTION OF THE DRAWINGS

FIG. 1 is a diagram illustrating an embodiment of a communication infrastructure.

FIG. 2A is a diagram illustrating an embodiment of a computing device.

FIG. 2B is a diagram illustrating an embodiment of a computing device.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Customer interaction management comprises managing interactions between customers and agents, customers and bots, or a mixture of both, in a contact center or enterprise environment, across any number of channels, tracking and targeting the best possible resources (agent or self-service) based on skills, and/or any number of parameters. Reporting may be done on channel interactions and outcomes in real-time and in a historical manner. Models may be generated to predict outcomes. From the analysis, a best possible match between waiting interactions and contact center resources (e.g., agents, chat bots, blended agent and chat bot handling, etc.) can be determined and the interactions routed accordingly. Reporting may also be made on the predicted versus the actual outcomes in order to further train the machine-learning model, improving the accuracy of predicted outcomes between similar customer profiles and agent profiles.

All interactions that a customer takes relating to the same service, need, or purpose may be described as the customer's journey. Analytics around the customer's journey may be referred to as ‘journey analytics’. For example, if a customer is browsing company A's e-store website, logs in with their credentials, makes a purchase, and then calls the company A customer-support line within a certain period from that online-purchase action, there is a high probability the customer is calling about the online order just made (e.g., inquiring why the item has not shipped, upgrading to overnight shipping, etc.). All interactions made by the customer in this example comprise one journey. The ability to determine in advance whether a majority of calls made in the support line are about shipping inquiries can provide Company A to send a proactive notification to customers about order confirmation, tracking numbers, and possibilities to upgrade shipping methods via a channel (e.g., email, SMS, callback, etc.).

Recognizing the moment in a journey a customer is in and taking actions proactively can provide better customer service and outcomes. Using the demographics of a customer to match that customer to an agent for an incoming interaction adds a personal touch of connecting a customer with a comparable agent. Traditional routing is designed to match interactions to agents through skills-based or group-based logic rather than improving KPI. Predictive Routing utilizes machine learning to find signals in historical data to build a predictive model. This model improves KPIs by ranking agents before making the match with the customer in an interaction. For example, the phone number, IP address, or email address can be anonymized via an application within a contact center or a third-party application and used in the matching of an agent with a customer for an interaction as opposed to solely using telephony parameters. In another example, a young, social, and relatively inexperienced customer may be matched with a patient and chatty agent. An older, busy executive might be matched with a more direct and highly trained agent. As a result, better Net Promoter Scores may be achieved for all customers engaging with the contact center.

However, when an interaction is a chat, the personal touch of connecting with a compatible agent may be lost because chat bots servicing the contact center provide the same natural language understanding models, a single expressive personality, and a uniformed intent set. Customers may begin a business interaction via a website or a mobile application. As such, predictive routing in the sense of providing the personality matches of agents to customers may not apply to bots being matched to customers. Thus, the best customer experience may not be achieved for the young, social and inexperienced customer as previously mentioned as they would encounter the same bot as the experienced executive. It is unlikely that both the inexperienced and the more experienced customers would find the same experience pleasing and thus, routing to bots becomes problematic from a customer experience point of view.

### Contact Center Systems

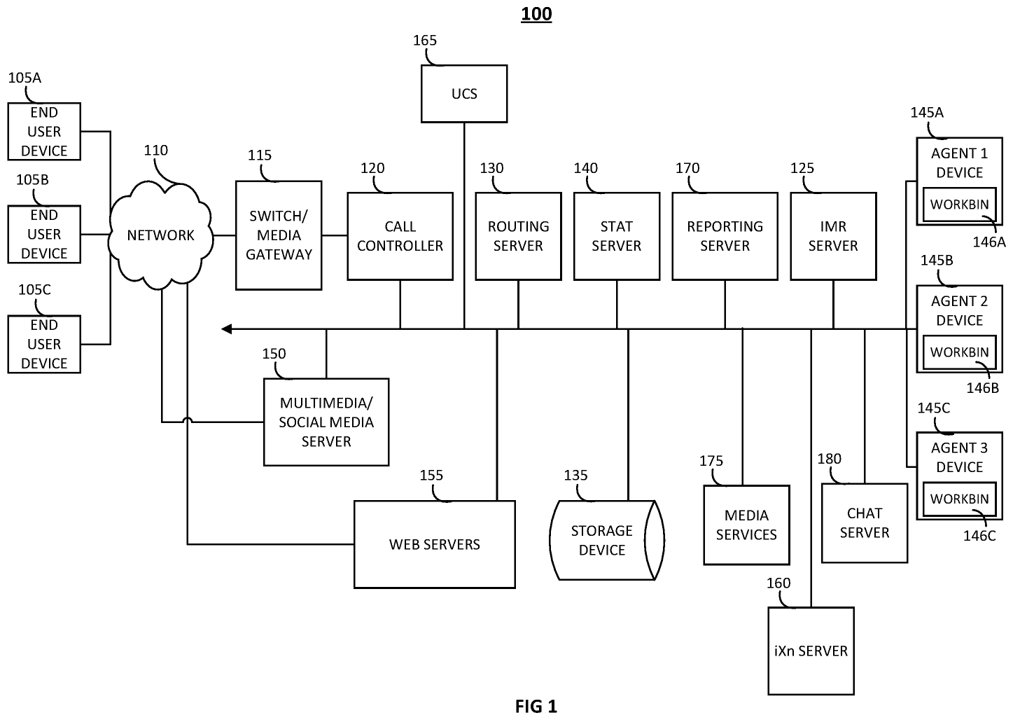

FIG. 1 is a diagram illustrating an embodiment of a communication infrastructure, indicated generally at 100. For example, FIG. 1 illustrates a system for supporting a contact center in providing contact center services. The contact center may be an in-house facility to a business or enterprise for serving the enterprise in performing the functions of sales and service relative to the products and services available through the enterprise. In another aspect, the contact center may be operated by a third-party service provider. In an embodiment, the contact center may operate as a hybrid system in which some components of the contact center system are hosted at the contact center premises and other components are hosted remotely (e.g., in a cloud-based environment). The contact center may be deployed on equipment dedicated to the enterprise or third-party service provider, and/or deployed in a remote computing environment such as, for example, a private or public cloud environment with infrastructure for supporting multiple contact centers for multiple enterprises. The various components of the contact center system may also be distributed across various geographic locations and computing environments and not necessarily contained in a single location, computing environment, or even computing device.

Components of the communication infrastructure indicated generally at 100 include: a plurality of end user devices 105A, 105B, 105C; a communications network 110; a switch/media gateway 115; a call controller 120; an IMR server 125; a routing server 130; a storage device 135; a stat server 140; a plurality of agent devices 145A, 145B, 145C comprising workbins 146A, 146B, 146C; a multimedia/social media server 150; web servers 155; an iXn server 160; a UCS 165; a reporting server 170; and media services 175.

In an embodiment, the contact center system manages resources (e.g., personnel, computers, telecommunication equipment, etc.) to enable delivery of services via telephone or other communication mechanisms. Such services may vary depending on the type of contact center and may range from customer service to help desk, emergency response, telemarketing, order taking, etc.

Customers, potential customers, or other end users (collectively referred to as customers or end users) desiring to receive services from the contact center may initiate inbound communications (e.g., telephony calls, emails, chats, etc.) to the contact center via end user devices 105A, 105B, and 105C (collectively referenced as 105). Each of the end user devices 105 may be a communication device conventional in the art, such as a telephone, wireless phone, smart phone, personal computer, electronic tablet, laptop, etc., to name some non-limiting examples. Users operating the end user devices 105 may initiate, manage, and respond to telephone calls, emails, chats, text messages, web-browsing sessions, and other multi-media transactions. While three end user devices 105 are illustrated at 100 for simplicity, any number may be present.

Inbound and outbound communications from and to the end user devices 105 may traverse a network 110 depending on the type of device that is being used. The network 110 may comprise a communication network of telephone, cellular, and/or data services and may also comprise a private or public switched telephone network (PSTN), local area network (LAN), private wide area network (WAN), and/or public WAN such as the Internet, to name a non-limiting example. The network 110 may also include a wireless carrier network including a code division multiple access (CDMA) network, global system for mobile communications (GSM) network, or any wireless network/technology conventional in the art, including but not limited to 3G, 4G, LTE, etc.

In an embodiment, the contact center system includes a switch/media gateway 115 coupled to the network 110 for receiving and transmitting telephony calls between the end users and the contact center. The switch/media gateway 115 may include a telephony switch or communication switch configured to function as a central switch for agent level routing within the center. The switch may be a hardware switching system or a soft switch implemented via software. For example, the switch 115 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, an agent telephony or communication device. In this example, the switch/media gateway establishes a voice path/connection (not shown) between the calling customer and the agent telephony device, by establishing, for example, a connection between the customer's telephony device and the agent telephony device.

In an embodiment, the switch is coupled to a call controller 120 which may, for example, serve as an adapter or interface between the switch and the remainder of the routing, monitoring, and other communication-handling components of the contact center. The call controller 120 may be configured to process PSTN calls, VoIP calls, etc. For example, the call controller 120 may be configured with computer-telephony integration (CTI) software for interfacing with the switch/media gateway and contact center equipment. In an embodiment, the call controller 120 may include a session initiation protocol (SIP) server for processing SIP calls. The call controller 120 may also extract data about the customer interaction, such as the caller's telephone number (e.g., the automatic number identification (ANI) number), the customer's internet protocol (IP) address, or email address, and communicate with other components of the system 100 in processing the interaction.

In an embodiment, the system 100 further includes an interactive media response (IMR) server 125. The IMR server 125 may also be referred to as a self-help system, a virtual assistant, etc. The IMR server 125 may be similar to an interactive voice response (IVR) server, except that the IMR server 125 is not restricted to voice and additionally may cover a variety of media channels. In an example illustrating voice, the IMR server 125 may be configured with an IMR script for querying customers on their needs. For example, a contact center for a bank may tell customers via the IMR script to ‘press 1’ if they wish to retrieve their account balance. Through continued interaction with the IMR server 125, customers may be able to complete service without needing to speak with an agent. The IMR server 125 may also ask an open-ended question such as, “How can I help you?” and the customer may speak or otherwise enter a reason for contacting the contact center. The customer's response may be used by a routing server 130 to route the call or communication to an appropriate contact center resource.

If the communication is to be routed to an agent, the call controller 120 interacts with the routing server (also referred to as an orchestration server) 130 to find an appropriate agent for processing the interaction. The selection of an appropriate agent for routing an inbound interaction may be based, for example, on a routing strategy employed by the routing server 130, and further based on information about agent availability, skills, and other routing parameters provided, for example, by a statistics server 140. In another embodiment, the communication may be routed to a chat bot via a platform on a chat server 180 (as further described below).

In an embodiment, the routing server 130 may query a customer database, which stores information about existing clients, such as contact information, service level agreement (SLA) requirements, nature of previous customer contacts and actions taken by the contact center to resolve any customer issues, etc. The database may be, for example, Cassandra or any NoSQL database, and may be stored in a mass storage device 135. The database may also be a SQL database and may be managed by any database management system such as, for example, Oracle, IBM DB2, Microsoft SQL server, Microsoft Access, PostgreSQL, etc., to name a few non-limiting examples. The routing server 130 may query the customer information from the customer database via an ANI or any other information collected by the IMR server 125.

Once an appropriate agent is identified as being available to handle a communication, a connection may be made between the customer and an agent device 145A, 145B and/or 145C (collectively referenced as 145) of the identified agent. While three agent devices are illustrated in FIG. 1 for simplicity, any number of devices may be present. Collected information about the customer and/or the customer's historical information may also be provided to the agent device for aiding the agent in better servicing the communication and additionally to the contact center admin/supervisor device for managing the contact center. In this regard, each device 145 may include a telephone adapted for regular telephone calls, VoIP calls, etc. The device 145 may also include a computer for communicating with one or more servers of the contact center and performing data processing associated with contact center operations, and for interfacing with customers via voice and other multimedia communication mechanisms.

The contact center system 100 may also include a multimedia/social media server 150 for engaging in media interactions other than voice interactions with the end user devices 105 and/or web servers 155. The media interactions may be related, for example, to email, vmail (voice mail through email), chat, video, text-messaging, web, social media, co-browsing, etc. The multi-media/social media server 150 may take the form of any IP router conventional in the art with specialized hardware and software for receiving, processing, and forwarding multi-media events.

The web servers 155 may include, for example, social interaction site hosts for a variety of known social interaction sites to which an end user may subscribe, such as Facebook, Twitter, Instagram, etc., to name a few non-limiting examples. In an embodiment, although web servers 155 are depicted as part of the contact center system 100, the web servers may also be provided by third parties and/or maintained outside of the contact center premise. The web servers 155 may also provide web pages for the enterprise that is being supported by the contact center system 100. End users may browse the web pages and get information about the enterprise's products and services. The web pages may also provide a mechanism for contacting the contact center via, for example, web chat, voice call, email, web real-time communication (WebRTC), etc. Widgets may be deployed on the websites hosted on the web servers 155.

In an embodiment, deferrable interactions/activities may also be routed to the contact center agents in addition to real-time interactions. Deferrable interaction/activities may comprise back-office work or work that may be performed off-line such as responding to emails, letters, attending training, or other activities that do not entail real-time communication with a customer. An interaction (iXn) server 160 interacts with the routing server 130 for selecting an appropriate agent or entity (e.g., a chat bot) to handle the activity. In an embodiment, once the interaction is assigned to an agent, an activity may be pushed to the agent, or may appear in the agent's workbin 146A, 146B, 146C (collectively 146) as a task to be completed by the agent. The agent's workbin may be implemented via any data structure conventional in the art, such as, for example, a linked list, array, etc. In an embodiment, a workbin 146 may be maintained, for example, in buffer memory of each agent device 145.

In an embodiment, the interaction is assigned to a bot for handling. The interaction server 160 will route the interaction to a chat server 180, which communicates via platform with the bot. The chat server 180 is capable of conducting a plurality of chat sessions with a bot. A platform implemented on the server deploys various chat bots which participate in the chat sessions. A workflow initiates and stops the bot, as well as sending data to the bot.

In an embodiment, the mass storage device(s) 135 may store one or more databases relating to agent data (e.g., agent profiles, schedules, etc.), customer data (e.g., customer profiles), interaction data (e.g., details of each interaction with a customer, including, but not limited to: reason for the interaction, disposition data, wait time, handle time, etc.), and the like. In another embodiment, some of the data (e.g., customer profile data) may be maintained in a customer relations management (CRM) database hosted in the mass storage device 135 or elsewhere. The mass storage device 135 may take form of a hard disk or disk array as is conventional in the art.

In an embodiment, the contact center system may include a universal contact server (UCS) 165, configured to retrieve information stored in the CRM database and direct information to be stored in the CRM database. The UCS 165 may also be configured to facilitate maintaining a history of customers' preferences and interaction history, and to capture and store data regarding comments from agents, customer communication history, etc.

The contact center system may also include a reporting server 170 configured to generate reports from data aggregated by the statistics server 140. Such reports may include near real-time reports or historical reports concerning the state of resources, such as, for example, average wait time, abandonment rate, agent occupancy, etc. The reports may be generated automatically or in response to specific requests from a requestor (e.g., agent/administrator, contact center application, etc.).

The various servers of FIG. 1 may each include one or more processors executing computer program instructions and interacting with other system components for performing the various functionalities described herein. The computer program instructions are stored in a memory implemented using a standard memory device, such as for example, a random-access memory (RAM). The computer program instructions may also be stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the embodiments of the present invention.

In an embodiment, the terms “interaction” and “communication” are used interchangeably, and generally refer to any real-time and non-real-time interaction that uses any communication channel including, without limitation, telephony calls (PSTN or VoIP calls), emails, vmails, video, chat, screen-sharing, text messages, social media messages, WebRTC calls, etc.

The media services 175 may provide audio and/or video services to support contact center features such as prompts for an IVR or IMR system (e.g., playback of audio files), hold music, voicemails/single party recordings, multi-party recordings (e.g., of audio and/or video calls), speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, and keyword spotting.

In an embodiment, the premises-based platform product may provide access to and control of components of the system 100 through user interfaces (UIs) present on the agent devices 145A-C. Within the premises-based platform product, the graphical application generator program may be integrated which allows a user to write the programs (handlers) that control various interaction processing behaviors within the premises-based platform product.

As noted above, the contact center may operate as a hybrid system in which some or all components are hosted remotely, such as in a cloud-based environment. For the sake of convenience, aspects of embodiments of the present invention will be described below with respect to providing modular tools from a cloud-based environment to components housed on-premises.

In an embodiment, a collection of chat bots (or, a plurality of bots) related to the contact center may be provided that can support the mechanism of predictive routing through mapping customers to personalized bots in the collection of bots as opposed to the contact center having a single bot to handle interactions. The chat bots are constructed using a generic bot building software platform. When the bot is being constructed, a plurality of dimensions are inspected from the historical interactions for the contact center. The agents are then inspected and grouped similarly to how the agents would be grouped for routing. A processor determines which clusters an agent should belong to and how many bots should represent that cluster.

The bots may be built through examining historical conversations within the contact center or enterprise environment between agents and customers, or two parties. These may be transcripts of voice conversations or web chat transcripts. The interactions may be segmented by agent to examine differences in personalities of the human agents. A variety of bot personalities may be constructed to represent the different personalities in three dimensions, for example: the utterances used to train the bot's recognition, the intents that the bot supports, and the responses the agent provides to the customer.

In an embodiment, a bot can be trained on utterances that are collected from historical chat conversations (e.g., the agent transcripts) that are segmented. This segmentation and classification comprises a post-processing step of predictive routing. Agents who are classified in a certain way (e.g. chatty, direct, patient, etc.) can be further used to segment the utterance training so that a specific bot instantiation would be trained on utterances typical of a customer who prefers that agent classification. Classifications can also be both subtle and/or direct. For example, pace of conversation (speaking at 1.1 times speed versus 9 times speed) for subtle classifications. A more direct classification may be language, such as whether the agent handles English conversation or Japanese conversations. Conversely, the standard process for training bots collects all of the utterances from all of the customers regardless of any segmentation. Embodiments described herein segment the utterances based on the target agent/group of predictive routing for diversity in routing to the chat bots.

Thus, predictive routing technology creates a segmented utterance set—one per agent or grouping of similar agent personas. A chat bot that is exposed to utterances solely from a customer segment that prefers an agent classification would recognize that customer segment better than a bot that is trained from a generic set of utterances. Likewise, the intents that a bot can support can also be reflective of the utterance training for the specific classification of an agent. This reduction of intent set eliminates a misrecognition by the bot into an intent that is outside of the customer demographic and leads to less confusion for the customer (and a more pleasant experience).

In an embodiment, the responses of the bot can also be tailored to the personality typical for the agent classification. Each bot response can be syntactically different based on the bot segmentation.

Thus, a “young” bot would quite literally sound different in word choice and mannerism than an “older/experienced” bot. For example, Cliff and Dan both (independently) start a chat session with bots on a farming machine website. This online chat is a new feature for the website. In the past, predictive routing has been sending Cliff to live agents that match his personality (young, hip, and not so experienced in farm equipment maintenance). Dan, however, has normally been routed to old gruff agents who can recall the part numbers for Ford 8N tractors from memory. Sam, on the other hand, is routed to agents who are chatty and tend to discuss the weather and price of corn with him when he calls to order parts. When each of Dan, Cliff, and Sam initiate interactions with the contact center, they are this time routed to a chat bot considered the best match from the grouping of chat bots within the contact center designed to give each of them the best customer experience.

When Cliff engages with the chat bot, the greeting from the bot is effusive and uses terminology to his generation (e.g., emoticons, shorthand terms like LOL, etc.). It also easily understands Cliff's questions about “that round thing spinning at the rear of the tractor” and then helps Cliff purchase an umbrella clamp.

When Dan engages with the bot, it starts out with a prompt about current shipping times. It understands Dan's cryptic request for a clutch bearing part (he gave the part number) and displays that there are three in stock. A simple one-word confirmation from Dan and the part is shipped overnight.

When Sam (an agricultural enthusiast), engages with the bot, the bot asks him how the weather in Indiana is and how he feels about the recent drop in the price per bushel of corn. Sam and the bot may exchange in a few pleasantries (or more depending on Sam's break time and how long he chats before getting around to mentioning his parts request).

In an embodiment, an interaction may be analyzed by a processor post-call and determined that the chat bot assigned originally to an interaction is performing well below standards (e.g., the performance threshold is significantly lower compared to a similar person of agents in the contact center). A notification may be set out to let an administrator know that a new bot persona may need to be created to address this emerging persona. The customer may be found to be saying new words or speaking in a more modern manner. As such, a new bot can be created by examining the performance of segmented groups of bots for drop offs of certain demographics or personas.

Determining the number of bots to create for an environment is subjective. Having too few bots does not provide enough personalization but too many is expensive to maintain through both time and money. In an example, if there are 10 agents, each agent could be separated into their own pool. Two bots could be constructed to represent each of the agent pools, for a total of 20 bots. Each bot recognizes the vocabulary from each of their respective agents in the associated pool to personify each of the agents.

In an embodiment, a bot may be tailored to a particular enterprise environment. Different areas or departments within the enterprise may have different personas. For example, HR may have a different persona than a bot in IT, Customer Care, or the Facilities groups.

In another embodiment, a bot persona may vary based on the interaction channel A bot may communicate differently through an SMS channel versus a voice channel due to word constraints in the SMS channel A voice channel allows for longer communications and could also have a larger vocabulary than an SMS channel bot.

In another embodiment, an interaction could be routed to multiple chat bots during an interaction, if it is determined in real-time during the interaction through continuous monitoring that the first chat bot the interaction was routed to is not performing well. This may be through keyword spotting or through a request by a customer to be transferred, or the bot determining that the interaction should be routed for better handling. The interaction may be re-routed through the same processes previously described to a different chat bot that may be another match. The process of re-routing could happen a plurality of times throughout the process.

### Computer Systems

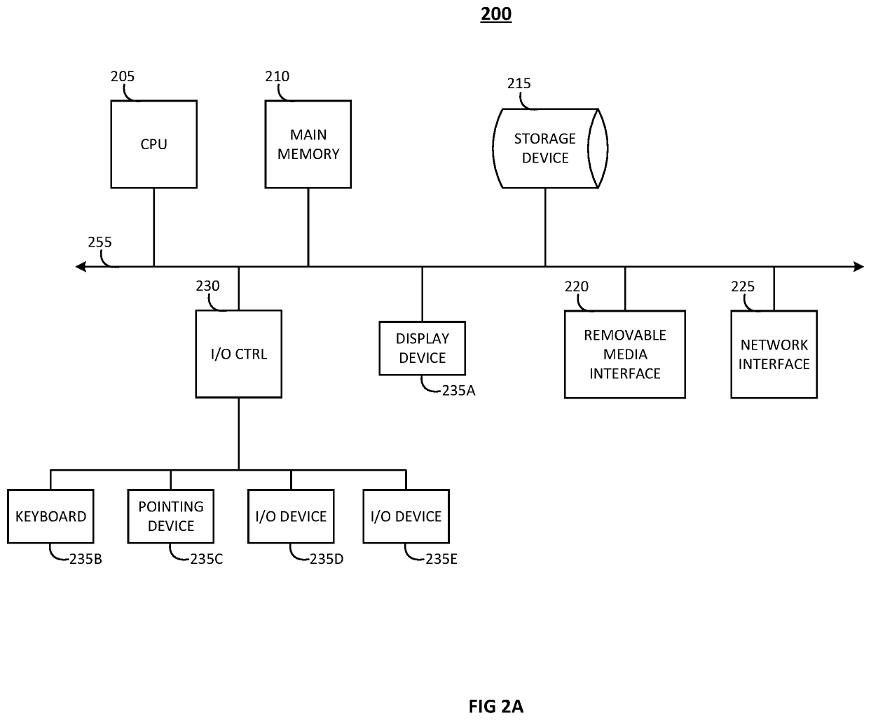

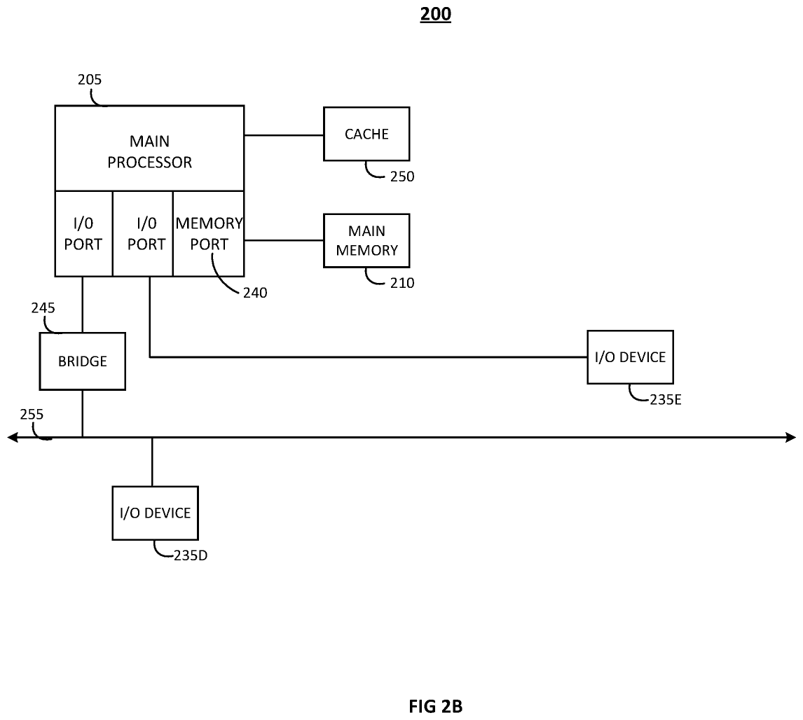

In an embodiment, each of the various servers, controls, switches, gateways, engines, and/or modules (collectively referred to as servers) in the described figures are implemented via hardware or firmware (e.g., ASIC) as will be appreciated by a person of skill in the art. Each of the various servers may be a process or thread, running on one or more processors, in one or more computing devices (e.g., FIGS. 2A, 2B), executing computer program instructions and interacting with other system components for performing the various functionalities described herein. The computer program instructions are stored in a memory which may be implemented in a computing device using a standard memory device, such as, for example, a RAM. The computer program instructions may also be stored in other non-transitory computer readable media such as, for example, a CD-ROM, a flash drive, etc. A person of skill in the art should recognize that a computing device may be implemented via firmware (e.g., an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the exemplary embodiments of the present invention. A server may be a software module, which may also simply be referred to as a module. The set of modules in the contact center may include servers, and other modules.

The various servers may be located on a computing device on-site at the same physical location as the agents of the contact center or may be located off-site (or in the cloud) in a geographically different location, e.g., in a remote data center, connected to the contact center via a network such as the Internet. In addition, some of the servers may be located in a computing device on-site at the contact center while others may be located in a computing device off-site, or servers providing redundant functionality may be provided both via on-site and off-site computing devices to provide greater fault tolerance. In some embodiments, functionality provided by servers located on computing devices off-site may be accessed and provided over a virtual private network (VPN) as if such servers were on-site, or the functionality may be provided using a software as a service (SaaS) to provide functionality over the internet using various protocols, such as by exchanging data using encoded in extensible markup language (XML) or JSON.

FIGS. 2A and 2B are diagrams illustrating an embodiment of a computing device as may be employed in an embodiment of the invention, indicated generally at 200. Each computing device 200 includes a CPU 205 and a main memory unit 210. As illustrated in FIG. 2A, the computing device 200 may also include a storage device 215, a removable media interface 220, a network interface 225, an input/output (I/O) controller 230, one or more display devices 235A, a keyboard 235B and a pointing device 235C (e.g., a mouse). The storage device 215 may include, without limitation, storage for an operating system and software. As shown in FIG. 2B, each computing device 200 may also include additional optional elements, such as a memory port 240, a bridge 245, one or more additional input/output devices 235D, 235E, and a cache memory 250 in communication with the CPU 205. The input/output devices 235A, 235B, 235C, 235D, and 235E may collectively be referred to herein as 235.

The CPU 205 is any logic circuitry that responds to and processes instructions fetched from the main memory unit 210. It may be implemented, for example, in an integrated circuit, in the form of a microprocessor, microcontroller, or graphics processing unit, or in a field-programmable gate array (FPGA) or application-specific integrated circuit (ASIC). The main memory unit 210 may be one or more memory chips capable of storing data and allowing any storage location to be directly accessed by the central processing unit 205. As shown in FIG. 2A, the central processing unit 205 communicates with the main memory 210 via a system bus 255. As shown in FIG. 2B, the central processing unit 205 may also communicate directly with the main memory 210 via a memory port 240.

In an embodiment, the CPU 205 may include a plurality of processors and may provide functionality for simultaneous execution of instructions or for simultaneous execution of one instruction on more than one piece of data. In an embodiment, the computing device 200 may include a parallel processor with one or more cores. In an embodiment, the computing device 200 comprises a shared memory parallel device, with multiple processors and/or multiple processor cores, accessing all available memory as a single global address space. In another embodiment, the computing device 200 is a distributed memory parallel device with multiple processors each accessing local memory only. The computing device 200 may have both some memory which is shared and some which may only be accessed by particular processors or subsets of processors. The CPU 205 may include a multicore microprocessor, which combines two or more independent processors into a single package, e.g., into a single integrated circuit (IC). For example, the computing device 200 may include at least one CPU 205 and at least one graphics processing unit.

In an embodiment, a CPU 205 provides single instruction multiple data (SIMD) functionality, e.g., execution of a single instruction simultaneously on multiple pieces of data. In another embodiment, several processors in the CPU 205 may provide functionality for execution of multiple instructions simultaneously on multiple pieces of data (MIMD). The CPU 205 may also use any combination of SIMD and MIMD cores in a single device.

FIG. 2B depicts an embodiment in which the CPU 205 communicates directly with cache memory 250 via a secondary bus, sometimes referred to as a backside bus. In other embodiments, the CPU 205 communicates with the cache memory 250 using the system bus 255. The cache memory 250 typically has a faster response time than main memory 210. As illustrated in FIG. 2A, the CPU 205 communicates with various I/O devices 235 via the local system bus 255. Various buses may be used as the local system bus 255, including, but not limited to, a Video Electronics Standards Association (VESA) Local bus (VLB), an Industry Standard Architecture (ISA) bus, an Extended Industry Standard Architecture (EISA) bus, a Micro Channel Architecture (MCA) bus, a Peripheral Component Interconnect (PCI) bus, a PCI Extended (PCI-X) bus, a PCI-Express bus, or a NuBus. For embodiments in which an I/O device is a display device 235A, the CPU 205 may communicate with the display device 235A through an Advanced Graphics Port (AGP). FIG. 2B depicts an embodiment of a computer 200 in which the CPU 205 communicates directly with I/O device 235E. FIG. 2B also depicts an embodiment in which local buses and direct communication are mixed: the CPU 205 communicates with I/O device 235D using a local system bus 255 while communicating with I/O device 235E directly.

A wide variety of I/O devices 235 may be present in the computing device 200. Input devices include one or more keyboards 235B, mice, trackpads, trackballs, microphones, and drawing tables, to name a few non-limiting examples. Output devices include video display devices 235A, speakers and printers. An I/O controller 230 as shown in FIG. 2A, may control the one or more I/O devices, such as a keyboard 235B and a pointing device 235C (e.g., a mouse or optical pen), for example.

Referring again to FIG. 2A, the computing device 200 may support one or more removable media interfaces 220, such as a floppy disk drive, a CD-ROM drive, a DVD-ROM drive, tape drives of various formats, a USB port, a Secure Digital or COMPACT FLASH™ memory card port, or any other device suitable for reading data from read-only media, or for reading data from, or writing data to, read-write media. An I/O device 235 may be a bridge between the system bus 255 and a removable media interface 220.

The removable media interface 220 may, for example, be used for installing software and programs. The computing device 200 may further include a storage device 215, such as one or more hard disk drives or hard disk drive arrays, for storing an operating system and other related software, and for storing application software programs. Optionally, a removable media interface 220 may also be used as the storage device. For example, the operating system and the software may be run from a bootable medium, for example, a bootable CD.

In an embodiment, the computing device 200 may include or be connected to multiple display devices 235A, which each may be of the same or different type and/or form. As such, any of the I/O devices 235 and/or the I/O controller 230 may include any type and/or form of suitable hardware, software, or combination of hardware and software to support, enable or provide for the connection to, and use of, multiple display devices 235A by the computing device 200. For example, the computing device 200 may include any type and/or form of video adapter, video card, driver, and/or library to interface, communicate, connect or otherwise use the display devices 235A. In an embodiment, a video adapter may include multiple connectors to interface to multiple display devices 235A. In another embodiment, the computing device 200 may include multiple video adapters, with each video adapter connected to one or more of the display devices 235A. In other embodiments, one or more of the display devices 235A may be provided by one or more other computing devices, connected, for example, to the computing device 200 via a network. These embodiments may include any type of software designed and constructed to use the display device of another computing device as a second display device 235A for the computing device 200. One of ordinary skill in the art will recognize and appreciate the various ways and embodiments that a computing device 200 may be configured to have multiple display devices 235A.

An embodiment of a computing device indicated generally in FIGS. 2A and 2B may operate under the control of an operating system, which controls scheduling of tasks and access to system resources. The computing device 200 may be running any operating system, any embedded operating system, any real-time operating system, any open source operation system, any proprietary operating system, any operating systems for mobile computing devices, or any other operating system capable of running on the computing device and performing the operations described herein.

The computing device 200 may be any workstation, desktop computer, laptop or notebook computer, server machine, handled computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 200 may have different processors, operating systems, and input devices consistent with the device.

In other embodiments, the computing device 200 is a mobile device. Examples might include a Java-enabled cellular telephone or personal digital assistant (PDA), a smart phone, a digital audio player, or a portable media player. In an embodiment, the computing device 200 includes a combination of devices, such as a mobile phone combined with a digital audio player or portable media player.

A computing device 200 may be one of a plurality of machines connected by a network, or it may include a plurality of machines so connected. A network environment may include one or more local machine(s), client(s), client node(s), client machine(s), client computer(s), client device(s), endpoint(s), or endpoint node(s) in communication with one or more remote machines (which may also be generally referred to as server machines or remote machines) via one or more networks. In an embodiment, a local machine has the capacity to function as both a client node seeking access to resources provided by a server machine and as a server machine providing access to hosted resources for other clients. The network may be LAN or WAN links, broadband connections, wireless connections, or a combination of any or all of the above. Connections may be established using a variety of communication protocols. In one embodiment, the computing device 200 communicates with other computing devices 200 via any type and/or form of gateway or tunneling protocol such as Secure Socket Layer (SSL) or Transport Layer Security (TLS). The network interface may include a built-in network adapter, such as a network interface card, suitable for interfacing the computing device to any type of network capable of communication and performing the operations described herein. An I/O device may be a bridge between the system bus and an external communication bus.

In an embodiment, a network environment may be a virtual network environment where the various components of the network are virtualized. For example, the various machines may be virtual machines implemented as a software-based computer running on a physical machine. The virtual machines may share the same operating system. In other embodiments, different operating system may be run on each virtual machine instance. In an embodiment, a “hypervisor” type of virtualizing is implemented where multiple virtual machines run on the same host physical machine, each acting as if it has its own dedicated box. The virtual machines may also run on different host physical machines.

Other types of virtualization are also contemplated, such as, for example, the network (e.g., via Software Defined Networking (SDN)). Functions, such as functions of session border controller and other types of functions, may also be virtualized, such as, for example, via Network Functions Virtualization (NFV).

In an embodiment, the use of LSH to automatically discover carrier audio messages in a large set of pre-connected audio recordings may be applied in the support process of media services for a contact center environment. For example, this can assist with the call analysis process for a contact center and removes the need to have humans listen to a large set of audio recordings to discover new carrier audio messages.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the invention as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

1. A system for routing an interaction with a customer to a first chat bot of a plurality of chat bots associated with a contact center environment, based on criteria for automatic handling in the contact center environment, comprising:
a processor; and
a memory in communication with the processor, the memory storing instructions that, when executed by the processor, causes the processor to route the interaction to the first chat bot by:
analyzing a plurality of dimensions of historical interactions associated with a profile of the customer to obtain one or more differentiators for the interaction;
comparing the one or more differentiators against the differentiators associated with each chat bot of the plurality of chat bots;
selecting the first chat bot that is a best match from the plurality of chat bots; and
routing the interaction to the first chat bot for handling.

2. The system of claim 1, wherein each of the plurality of chat bots has a distinct persona constructed from a plurality of dimensions associated with agent personalities in the contact center environment.

3. The system of claim 2, wherein an agent personality is associated with a cluster of similar agents for the contact center environment.

4. The system of claim 2, wherein the plurality of dimensions comprises one or more of: utterances for training a bot's recognition, intents a bot supports, and responses an agent provides.

5. The system of claim 1, wherein the plurality of dimensions comprises one or more of: utterances, intents, and customer responses.

6. A method for routing an interaction to a chat bot from a plurality of chat bots based on criteria for automatic handling in a contact center environment, comprising:
analyzing a plurality of dimensions of historical interactions associated with a profile of the customer to obtain one or more differentiators for the interaction;
comparing the one or more differentiators against the differentiators associated with each chat bot of the plurality of chat bots;
selecting a first chat bot that is a best match from the plurality of chat bots;
routing the interaction to the first chat bot for handling;
monitoring the interaction for changes, wherein the changes indicate the first chat bot is not a best match;
comparing the one or more differentiators against the differentiators associated with each chat bot of the plurality of chat bots;
selecting a second chat bot that is a best match from the plurality of chat bots; and
routing the interaction to the second chat bot for handling.

7. The method of claim 6, wherein the method further comprises:
continuing to monitor the interaction for changes, wherein the changes indicate the second chat bot is not a best match;
comparing the one or more differentiators against the differentiators associated with each chat bot of the plurality of chat bots;
selecting an other chat bot that is a best match from the plurality of chat bots; and
routing the interaction to the second chat bot for handling.

8. The method of claim 6, wherein each of the plurality of chat bots has a distinct persona constructed from a plurality of dimensions associated with agent personalities in the contact center environment.

9. The method of claim 8, wherein an agent personality is associated with a cluster of similar agents for the contact center environment.

10. The method of claim 8, wherein the plurality of dimensions comprises one or more of: utterances for training a bot's recognition, intents a bot supports, and responses an agent provides.

11. The method of claim 6, wherein the plurality of dimensions comprises one or more of: utterances, intents, and customer responses.

12. A system for routing an interaction with a customer to a first chat bot of a plurality of chat bots associated with a contact center environment, wherein, it is identified that a first chat bot does not meet a threshold for routing and a new chat bot is needed, based on criteria for automatic handling in the contact center environment, comprising:
a processor; and
a memory in communication with the processor, the memory storing instructions that, when executed by the processor, causes the processor to route the interaction to the first chat bot by:
analyzing a plurality of dimensions of historical interactions associated with a profile of the customer to obtain one or more differentiators for the interaction;
comparing the one or more differentiators against the differentiators associated with each chat bot of the plurality of chat bots;
selecting the first chat bot that is a best match from the plurality of chat bots;
determining that the first chat bot does not meet a performance threshold for the differentiators compared to a similar persona of agents in the contact center environment; and
creating a notification that a new chat bot is needed.

13. The system of claim 12, wherein the notification comprises data on new differentiators needed for the new chat bot to address the new persona.

14. The system of claim 12, wherein the plurality of dimensions comprises one or more of: utterances for training a bot's recognition, intents a bot supports, responses an agent provides, and responses a customer provides.
